(19) United States
(12) Patent Application Publication
(10) Pub. No.: US 2015/0032676 A1
(43) Pub. Date: Jan. 29, 2015

(54) SYSTEM AND METHOD FOR SEGMENTING SOCIAL MEDIA PARTICIPANTS BY ATTITUDINAL SEGMENT

(71) Applicants: Sheldon H. Smith, Toronto (CA); David M. Diamond, New York, NY (US); Kathi Kim-Ellen Hurst, Toronto (CA)

(72) Inventors: Sheldon H. Smith, Toronto (CA); David M. Diamond, New York, NY (US); Kathi Kim-Ellen Hurst, Toronto (CA)

(73) Assignee: Twenty-Ten, Inc., Toronto (CA)

(21) Appl. No.: 13/948,489

(22) Filed: Jul. 23, 2013

(51) Int. Cl. G06N 5/02; G06N 99/00

(52) U.S. Cl. CPC G06N 5/02; G06N 99/005
USPC 706/14; 706/46

(57) ABSTRACT

A system. The system includes a computing device, an instance module, a topics module, an analysis module, a matching module, a modeling module and a targeting module. The computing device includes a processor and is configured to access social media information. Each of the modules are communicably connected to the processor. The instance module is configured to identify at least one of the following: a high-frequency word included in the social media information, and a high-frequency phrase included in the accessed social media information. The topics module is configured to generate a dictionary of topics associated with the accessed social media information. The analysis module is configured to analyze data from a plurality of social media accounts to generate a social media database. The matching module is configured to match a survey respondent with an associated user name included in the social media database.

### BACKGROUND

This application discloses an invention which is related, generally and in various embodiments, to a system and method for segmenting social media participants by attitudinal segments.

Social media are becoming increasingly popular, but no one yet understands how to harness their power as a potential marketing tool. Most people agree that part of the potential power of social media lies in the ability to target individuals, but no one has yet developed anything more than primitive marketing tools. For example, some social media companies offer mass marketing solutions where all social media participants receive the same marketing messages. Others offer behaviorally targeted marketing solutions where different consumers receive different messages and offers based on specific behaviors they have exhibited (e.g., purchases made, websites visited, etc.).

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of a system;

FIG. 2 illustrates various embodiments of a computing system of the system of FIG. 1; and

FIG. 3 illustrates various embodiments of a method.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

As described in more detail hereinbelow, aspects of the invention may be implemented by a computing device and/or a computer program stored on a computer-readable medium. The computer-readable medium may comprise a disk, a device, and/or a propagated signal.

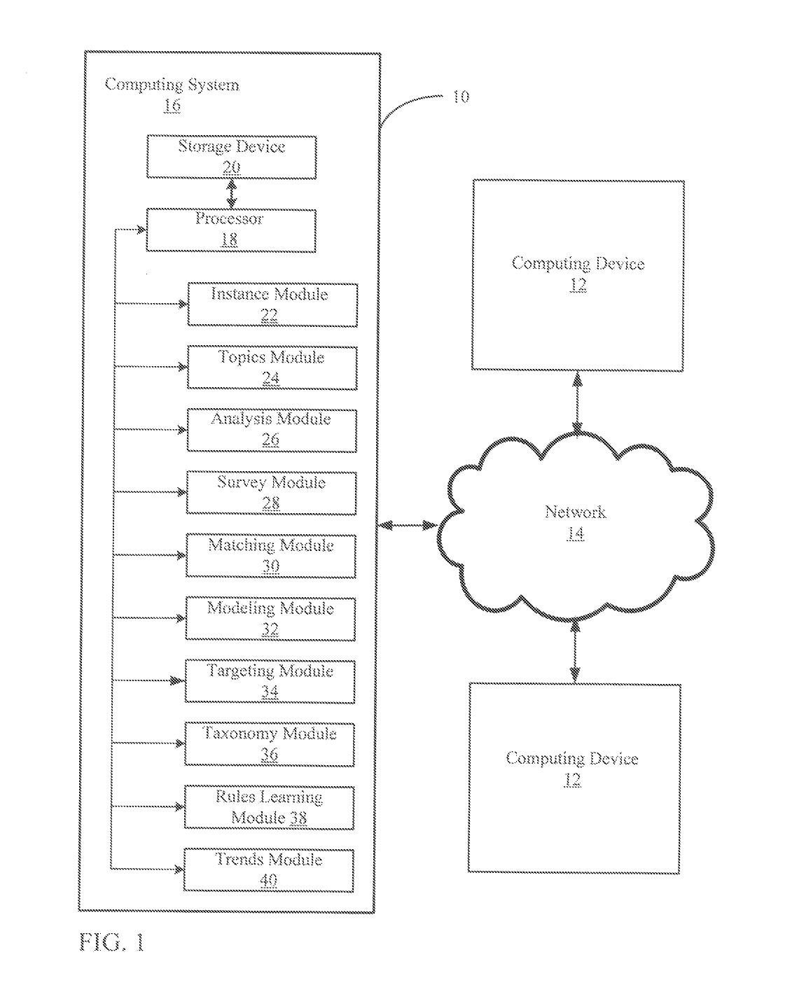

FIG. 1 illustrates various embodiments of a system 10. The system 10 may be utilized to segment social media participants (e.g., Twitter participants, Facebook participants, Google+ participants, Tumblr participants, YouTube participants, Dailymotion participants, blog participants, etc.) by attitudinal segments. In other words, the system 10 may be utilized to predict how closely a given consumer (who uses social media) reflects a given target attitudinal prospect profile. For purposes of simplicity, the system 10 will be described in the context of segmenting Twitter participants by attitudinal segments. However, it will be appreciated that the system 10 may be utilized to segment social media participants other than just Twitter participants by attitudinal segments.

As used herein, attitudinal segments are groupings of consumers having the same or similar attitudes. The attitudinal segments are formed based on attitudinal data (e.g., data which represents what people are thinking and how they feel). For example, why they are loyal to a given brand, why they have a preference for a given style, etc. Such data are derived from discussions with consumers, typically via surveys/questionnaires. As is appreciated by those skilled in the art of segmentation, attitudinal segments are distinct from and different than behavioral segments. Behavioral segments are groupings of consumers who have the same or similar behaviors, and are formed based on behavioral data (e.g., data which represent what people have done or will likely do). For example, what they buy, where they go, what they do, which movies they attend, how they spend their money, etc.

As shown in FIG. 1, the system 10 may be communicably connected to a plurality of computing devices 12 via one or more networks 14. The computing devices 12 may be embodied as servers, desktop computers, laptops, tablets, personal digital assistants, smart phones, etc. Each of the one or more networks 14 may include any type of delivery system including, but not limited to, a local area network (e.g., Ethernet), a wide area network (e.g. the Internet and/or World Wide Web), a telephone network (e.g., analog, digital, wired, wireless, PSTN, ISDN, GSM, GPRS, and/or xDSL), a packet-switched network, a radio network, a television network, a cable network, a satellite network, and/or any other wired or wireless communications network configured to carry data. A given network 14 may include elements, such as, for example, intermediate nodes, proxy servers, routers, switches, and adapters configured to direct and/or deliver data. In general, the system 10 may be structured and arranged to communicate with the computing devices 12 via the one or more networks 14 using various communication protocols (e.g., HTTP, TCP/IP, UDP, WAP, WiFi, Bluetooth) and/or to operate within or in concert with one or more other communications systems.

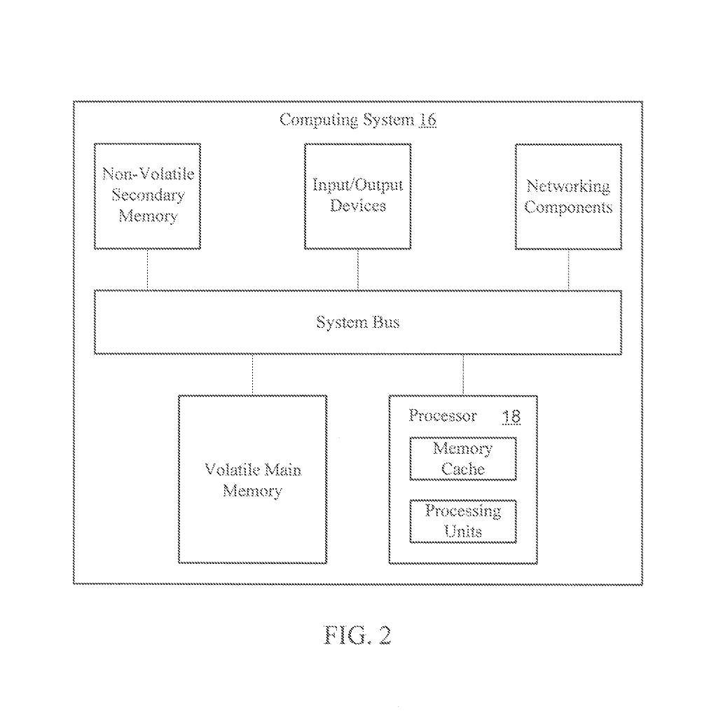

The system 10 includes a computing system 16. The computing system 16 may include any suitable type of computing device (e.g., a server, a desktop, a laptop, etc.) that includes at least one processor 18. Various embodiments of the computing system 16 are described in more detail hereinbelow with respect to FIG. 2.

FIG. 2 illustrates various embodiments of the computing system 16. The computing system 16 may be embodied as one or more computing devices, and includes networking components such as Ethernet adapters, non-volatile secondary memory such as magnetic disks, input/output devices such as keyboards and visual displays, volatile main memory, and a processor 18. Each of these components may be communicably connected via a common system bus. The processor 18 includes processing units and on-chip storage devices such as memory caches.

According to various embodiments, the computing system 16 includes one or more modules which are implemented in software, and the software is stored in non-volatile memory devices while not in use. When the software is needed, the software is loaded into volatile main memory. After the software is loaded into volatile main memory, the processor 18 reads software instructions from volatile main memory and performs useful operations by executing sequences of the software instructions on data which are read into the processor 20 from volatile main memory. Upon completion of the useful operations, the processor 18 writes certain data results to volatile main memory.

Returning to FIG. 1, the system 10 also includes a storage device 20, an instance module 22, a topics module 24, an analysis module 26, a survey module 28, a matching module 30, a modeling module 32 and a targeting module 34. According to various embodiments, the system 10 may also include a taxonomy module 36, a rule learning module 38 and a trends module 40.

The storage device 20 is communicably connected to the processor 18, and may be any suitable type of storage device. Although the storage device 20 is shown in FIG. 1 as being integral with the computing system 12, it will be appreciated that according to other embodiments, the storage device 20 is communicably connected to, but not necessary integral with, the computing system 12.

The instance module 22 is communicably connected to the processor 18, and is configured to analyze the composition of accessed Tweets/re-Tweets to identify high-frequency words and/or phrases used in these Tweets/re-Tweets. According to various embodiments, the instance module 22 is configured to perform a co-occurrence analysis to identify the high-frequency words and/or phrases used in the Tweets/re-Tweets.

The topics module 24 is communicably connected to the processor 18, and is configured to generate a dictionary of “topics” used by the consumers in the accessed Tweets/re-Tweets. According to various embodiments, the topics module 24 is configured to annotate Tweets/re-Tweets which include certain permutations of a given word as containing a topic associated with the given word. According to various embodiments, the topics module 24 is also configured to annotate certain permutations of a given phrase as containing a topic associated with the given phrase.

The analysis module 26 is communicably connected to the processor 18, and is configured to analyze data from a large number of social media accounts (e.g., millions of Twitter accounts) to generate a “social media” database. According to various embodiments, the generated database includes, for each Twitter account, the following data points: the user name, the Tweets/re-Tweets, the topics which are included in the Tweets/re-Tweets, and how often mentions of the topics appear in the Tweets/re-Tweets. According to various embodiments, the database resides at the storage device 20.

The survey module 28 is communicably connected to the processor 18, and is configured to receive survey response data from a number of Twitter account IDs. According to various embodiments, the survey module 28 is configured to send invitations to a number of randomly selected Twitter account IDs to participate in an attitudinal survey. The invitation may include a link to an online survey which is designed to capture attitudinal data associated with the Twitter account holders. In general, the survey is designed to capture attitudinal data that can be used to define potential consumers who most closely fit an advertiser's ideal attitudinal target.

The matching module 30 is communicably connected to the processor 18, and is configured to match survey respondents with the associated user name in the generated social media database. The matching module 30 may also be configured to append variables associated with the survey responses to the individual records of the social media database.

The modeling module 32 is communicably connected to the processor 18, and is configured to generate a predictive algorithm which predicts how closely the respective survey respondents fit a desired target attitudinal profile. The modeling module 32 utilizes the survey response information, as well as the text usage and frequency values for each survey respondent, to generate the predictive algorithm. In general, the survey response information and the text usage and frequency values are utilized as independent variables by the modeling module 32 to build the predictive algorithm.

The targeting module 34 is communicably connected to the processor 18, and is configured to apply the predictive algorithm to all of the Twitter account IDs in the generated “social media” database to score and rank each Twitter account based on their predicted “fit” with the desired target attitudinal profile (classification analysis). According to various embodiments, various aspects of the targeting module 34 may be similar to the targeting engines described, for example, in U.S. Pat. Nos. 7,472,072 and 7,835,940.

The taxonomy module 36 is communicably connected to the processor 18, and is configured to utilize taxonomy identification to create a number of conceptual levels of information (e.g., level 1: soft drink; level 2: sugar drink and diet drink; and level 3: Sprite, Coke, Dr. Pepper, Sprite Light, Diet Coke and Diet Dr. Pepper). According to various embodiments, for instances where Tweets/re-Tweets include mentions about Sprite, Coke, Dr. Pepper, Sprite Light, Diet Coke and Diet Dr. Pepper, the taxonomy module 36 is also configured to annotate those Tweets/re-Tweets as containing mentions about soft drinks and diet drinks.

The rule learning module 38 is communicably connected to the processor 18, and is configured to utilize association rule learning (ARL) to extract additional insights into consumer behavior. For example, the rule learning module 38 may utilize ARL to identify unknown associations between products and/or topics and can be used to better understand how consumers relate these products and topics.

The trends module 40 is communicably connected to the processor 18, and is configured to perform text analytics on the Tweets/re-Tweets to identify emerging trends regarding specific products. According to various embodiments, the trends module 40 is configured to take the importance and interestingness of a topic or word which is suggested by Tweets/re-Tweets or the like into consideration when identifying the emerging trends.

The modules 22-40 may be implemented in hardware, firmware, software and combinations thereof. For embodiments utilizing software, the software may utilize any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The modules 22-40 (e.g., software application, computer program) may be stored on a computer-readable medium (e.g., disk, device, and/or propagated signal) such that when a computer reads the medium, the functions described herein-above are performed. According to various embodiments, the above-described functionality of the modules 22-40 may be combined into fewer modules, distributed differently amongst the modules, spread over additional modules, etc.

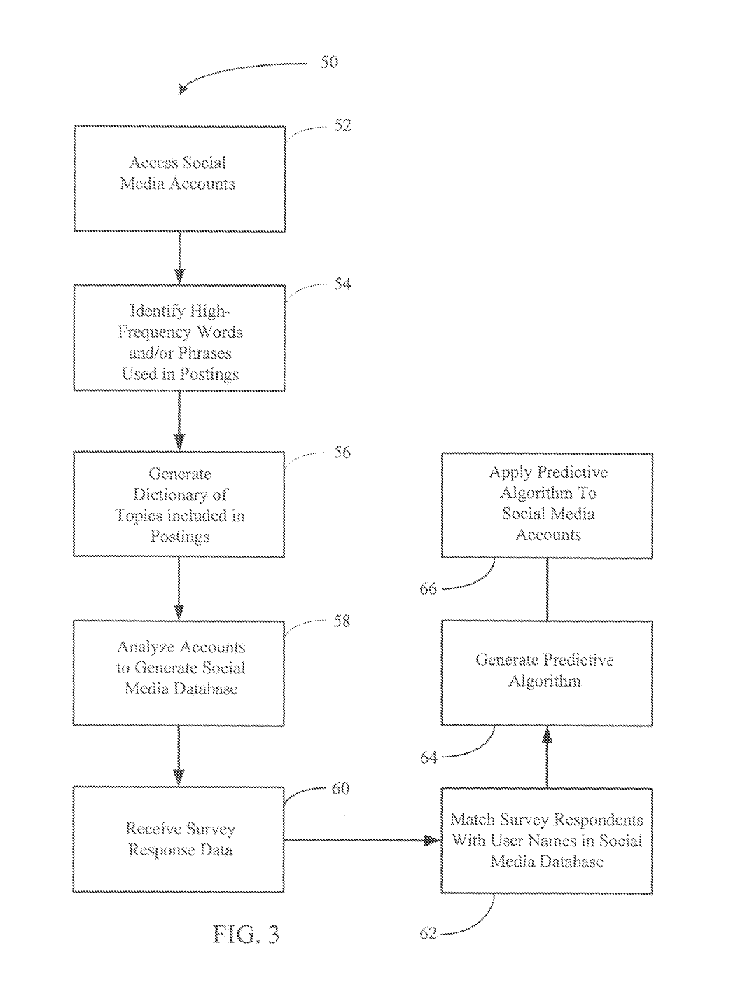

FIG. 3 illustrates various embodiments of a method 50. The method 50 may be implemented by the system 10, and may be utilized to segment social media participants (e.g., Twitter participants, Facebook participants, Google+ participants, Tumblr participants, YouTube participants, Dailymotion participants, blog participants, etc.) by attitudinal segments. In other words, the method 50 may be utilized to predict how closely a given consumer (who uses social media) reflects a given target attitudinal prospect profile. For purposes of simplicity, the method 50 will be described in the context of segmenting Twitter participants by attitudinal segments. However, it will be appreciated that the method 50 may be utilized to segment social media participants other than just Twitter participants by attitudinal segments.

The process starts at block 52, where a random selection of Twitter account IDs and recent text Tweets/re-Tweets communicated by each account ID are accessed by the computing system 12. For example, according to various embodiments, approximately 100,000 accounts may be accessed. Such access may be realized, for example, by accessing Twitter accounts which follow a given Twitter account (e.g., Tide® laundry detergent). Permission for performing these actions may be received from Twitter and/or the individual account holders. For example, permission may be received from the account holder of Tide® laundry detergent to follow the Tweets and/or re-Tweets where they are mentioned.

From block 52, the process advances to block 54, where the composition of the Tweets/re-Tweets accessed at block 52 are analyzed by the instance module 22 to identify high-frequency words and/or phrases used in these Tweets/re-Tweets. According to various embodiments, the instance module 22 may perform a co-occurrence analysis to identify the high-frequency words and/or phrases used in the Tweets/re-Tweets. For example, when a Twitter user writes about hand soap, the words hand, liquid, category, item, dish, dispenser, bar lotion and antibacterial may occur more frequently than other words. According to some embodiments, for a given account holder, all of the Tweets/re-Tweets accessed at block 52 are analyzed to identify the high-frequency words and/or phrases. According to other embodiments, for a given account holder, a more limited number (e.g., the last 50-100 Tweets/re-Tweets) of the accessed Tweets/re-Tweets are analyzed to identify the high-frequency words and/or phrases. According to various embodiments, trivial words such as “the”, “and”, “to”, etc. may be excluded from the analysis. Additionally, certain erroneous information (e.g., URL addresses, Twitter user names, special characters, etc.) may also be excluded from the analysis.

From block 54, the process advances to block 56, where the topics module 24 generates a dictionary of “topics” used by the consumers in the accessed Tweets/re-Tweets. For example, for the hand soap example above, based on the identified high-frequency words, the topics module 22 may create a topic named “dispense”. According to various embodiments, for any of the accessed Tweets/re-Tweets which include certain permutations of the word dispense (e.g., dispense, dispenses, dispensed, dispensing, etc.), the topics module 24 may annotate those Tweets/re-Tweets as containing the topic dispense. Similarly, the topics module 22 may annotate certain permutations of a given phrase as containing a topic related to the phrase. Thus, it will be appreciated that a given topic may be broader than a high-frequency word and/or phrase identified at block 54. The generated dictionary may include any number of topics.

From block 56, the process advances to block 58, where the analysis module 26 analyzes data from a large number of Twitter accounts (e.g., millions of Twitter accounts) to generate a “social media” database. The generated “social media” database may reside at the storage device 20. According to various embodiments, the database includes, for each Twitter account, the following data points: the user name, the Tweets/re-Tweets, the topics identified at block 56 which are included in the Tweets/re-Tweets, and how often mentions of the topics appear in the Tweets/re-Tweets (frequency values). For example, if the following text is Tweeted” “I just tried an antibacterial soap with a really cool dispenser. Yes, I think my hands are really clean now.”, the analysis module 26 will identify the topics antibacterial, soap, dispenser and clean within this Tweet, and will update the relevant record of the database with the fact that the Tweeter wrote/discussed about these topics “n” times in the past hour, day, month, year, etc. As described in more detail hereinafter, the data points can be used to predict how closely a given Twitter account holder fits a given target attitudinal profile.

From block 58, the process advances to block 60, where the survey module 28 receives survey response data from a number of Twitter account IDs. According to various embodiments, the survey module 28 sends invitations to some of the Twitter account IDs randomly selected at block 52 to participate in an attitudinal survey. The invitation may include a link to an online survey which is designed to capture attitudinal data associated with the Twitter account holders. In general, the survey is designed to capture attitudinal data that can be used to define potential consumers who most closely fit an advertiser's ideal attitudinal target. According to various embodiments, the survey response data are received from at least 2,000 respondents.

From block 60, the process advances to block 62, where the matching module 30 matches each survey respondent from block 60 with the associated user name in the social media database generated at block 58. Variables associated with the survey responses may then be appended to the individual records of the social media database.

From block 62, the process advances to block 64, where the modeling module 32 utilizes the survey response information, as well as the text usage and frequency values for each survey respondent, to generate a predictive algorithm which predicts how closely the respective survey respondents fit a desired target attitudinal profile. In general, the survey response information and the text usage and frequency values are utilized as independent variables by the modeling module 32 to build the predictive algorithm.

From block 64, the process advances to block 66, where a targeting module 34 applies the predictive algorithm generated at block 64 to all of the Twitter account IDs in the “social media” database generated at block 58 to score and rank each Twitter account based on their predicted “fit” with the desired target attitudinal profile (classification analysis). According to various embodiments, various aspects of the targeting module 34 may be similar to the targeting engines described in U.S. Pat. Nos. 7,472,072 and 7,835,940.

According to various embodiments, the taxonomy module 36 may utilize taxonomy identification to create a number of conceptual levels of information (e.g., level 1: soft drink; level 2: sugar drink and diet drink; and level 3: Sprite, Coke, Dr. Pepper, Sprite Light, Diet Coke and Diet Dr. Pepper). For instances where Tweets/re-Tweets include mentions about Sprite, Coke, Dr. Pepper, Sprite Light, Diet Coke and Diet Dr. Pepper, the taxonomy module 36 may annotate those Tweets/re-Tweets as containing mentions about soft drinks and diet drinks. Thus, even if consumer behavior can't be correctly predicted at a brand level (e.g., Sprite, Coke, etc.), by using the more general level (e.g., diet drinks), better model predictive accuracy and generalization (segmentation) in predicting consumer response may be realized.

According to various embodiments, the rule learning module 38 may utilize association rule learning (ARL) to extract additional insights into consumer behavior (e.g., by identifying which things group together and show up a lot of the time). The rule learning module 38 may utilize ARL to identify unknown associations between products and/or topics and can be used to better understand how consumers relate these products and topics.

According to various embodiments, the trends module 40 may perform text analytics to identify emerging trends regarding specific products, especially when it is important to understand what drives consumer interest. Trend identification is similar to the co-occurrence analysis performed at block 54, but is different in that the importance and interestingness of a topic or word which is suggested by Tweets/re-Tweets or the like is taken into consideration.

The process described at blocks 52-66 may be performed any number of times for any number of Tweets/re-Tweets. Additionally, as the functionality of the taxonomy module 36, the rule learning module 38 and the trends module 40 are non-linear with respect to the process described at blocks 52-66, it will be appreciated that the functionality of the taxonomy module 36, the rule learning module 38 and/or the trends module 40 can be realized concurrently with any of the processes described at blocks 52, at different times, in the same sequential order, in different sequences, etc.).

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the claimed invention and should not be construed to limit the scope thereof.

What is claimed is:

1. A system, comprising:
a computing device, wherein the computing device comprises a processor and is configured to access social media information;
an instance module communicably connected to the processor, wherein the instance module is configured to identify at least one of the following:
a high-frequency word included in the social media information; and
a high-frequency phrase included in the accessed social media information;
a topics module communicably connected to the processor, wherein the topics module is configured to generate a dictionary of topics associated with the accessed social media information;
an analysis module communicably connected to the processor, wherein the analysis module is configured to analyze data from a plurality of social media accounts to generate a social media database;
a matching module communicably connected to the processor, wherein the matching module is configured to match a survey respondent with an associated user name included in the social media database;
a modeling module communicably connected to the processor, wherein the modeling module is configured to generate a predictive algorithm which predicts how closely the survey respondent fits a desired target attitudinal profile; and
a targeting module communicably connected to the processor, wherein the targeting module is configured to apply the predictive algorithm to each user account in the generated social media database.

2. The system of claim 1, wherein the social media information comprises at least one of the following:
a Tweet; and
a re-Tweet.

3. The system of claim 1, wherein the social media information comprises at least one of the following:
a Facebook posting;
a Google+ posting; and
a Tumblr posting.

4. The system of claim 1, wherein the social media information comprises at least one of the following:
a YouTube video; and
a Dailymotion video.

5. The system of claim 1, wherein the social media information comprises information associated with a blog.

6. The system of claim 1, further comprising a survey module communicably connected to the processor, wherein the survey module is configured to receive survey response data.

7. The system of claim 1, further comprising a taxonomy module communicably connected to the processor, wherein the taxonomy module is configured to utilize taxonomy information to create conceptual levels of information.

8. The system of claim 1, further comprising a rule learning module communicably connected to the processor, wherein the rule learning module is configured to utilize association rule learning to extract insights into behavior of the survey respondent.

9. The system of claim 1, further comprising a trends module communicably connected to the processor, wherein the trends module is configured to perform text analytics on the social media information.

10. A method, implemented at least in part by a computing device, for segmenting social media participants by attitudinal segments, the method comprising:
accessing social media information, wherein the accessing is performed by the computing device;
identifying at least one of the following in the accessed social media information:
a high-frequency word; and
a high-frequency phrase;
generating a dictionary of topics included in the accessed social media information;
analyzing the social media information to generate a social media database, wherein the database comprises a plurality of data points, wherein the data points comprise, for each social media account:
a user name;
content of a posting for the social media account;
each topic included in the posting; and
a frequency with which each topic appears in the postings;
matching survey respondents with associated user names in the generated social media database;
generating a predictive algorithm which predicts how closely the respective survey respondents fit a desired target attitudinal profile; and
applying the predictive algorithm to each of the social media accounts in the generated social media database.

11. The method of claim 10, wherein accessing social media information comprises accessing the social media information from a random selection of social media accounts.

12. The method of claim 10, wherein accessing the social media information comprises accessing social information associated with at least one of the following:
a Tweet; and
a re-Tweet.

13. The method of claim 10, wherein accessing the social media information comprises accessing social information associated with at least one of the following:
a Facebook posting;
a Google+ posting; and
a Tumblr posting.

14. The method of claim 10, wherein accessing the social media information comprises accessing social information associated with at least one of the following:
a YouTube video; and
a Dailymotion video.

15. The method of claim 10, wherein accessing the social media information comprises accessing social information associated with a blog.

16. The method of claim 10, wherein generating the dictionary of topics comprises:
associating the at least one identified high-frequency word with a topic; and
annotating at least one permutation of the at least one identified high-frequency word as containing the topic.

17. The method of claim 10, wherein generating the dictionary of topics comprises:
associating the at least one identified high-frequency phrase with a topic; and
annotating at least one permutation of the at least one identified high-frequency phrase as containing the topic.

18. The method of claim 10, further comprising updating the social media database as additional social media information is analyzed.

19. The method of claim 10, further comprising appending at least one variable associated with at least one of the survey respondents to a record of the social media database.

20. The method of claim 10, wherein generating the predictive algorithm comprises generating the predictive algorithm based on at least the following:
survey response information;
text usage for each survey respondent; and
frequency values of topics for each survey respondent.
